(19) United States
(12) Patent Application Publication
(10) Pub. No.: US 2007/0184825 A1
(43) Pub. Date: Aug. 9, 2007

(54) Method and system for selecting a visited network to be used by a user equipment in a wireless communication system

(76) Inventors: Han-Na Lim, Siheung-si (KR); Chen-Ho Chin, Staines (GB); Ho Kyung Kim, Seoul (KR); Sung-Ho Choi, Gyeonggi-do (KR); O-Sok Song, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/651,104

(22) Filed: Jan. 9, 2007

(30) Foreign Application Priority Data
Jan. 9, 2006 (KR) 2006-2194

(51) Int. Cl. H04Q 7/20

(52) U.S. Cl. 455/422.1; 455/433

(57) ABSTRACT

Preference of a home public land mobile network (HPLMN) is applied when a roaming user equipment (UE) selects a visited public land mobile network (VPLMN). The roaming UE sends an available VPLMN list to the HPLMN. A control message of a non-access stratum (NAS) or an application can be used to receive a preferred VPLMN list from the HPLMN or to send the preferred VPLMN list after the HPLMN requests that the UE should send the available VPLMN list or without a request. The HPLMN manages a VPLMN to be used by the roaming UE and enables a user to receive a better service.

### CROSS-REFERENCE TO RELATED PATENT APPLICATION

This application claims the benefit under 35 U.S.C. §119(a) of a Korean Patent Application filed in the Korean Intellectual Property Office on Jan. 9, 2006 and assigned Serial No. 2006-2194, the entire disclosure of which is hereby incorporated by reference.

### BACKGROUND OF THE INVENTION

1. Field of the Invention

The present invention relates to a method and system for selecting a visited public land mobile network (VPLMN) in a roaming user equipment.

2. Description of the Related Art

FIG. 1 schematically illustrates an environment of a roaming user equipment (UE) to which the present invention is applied.

Public land mobile networks (PLMNs) are communication networks for providing users with a wireless communication service, and are conventionally classified in a provider unit. A home public land mobile network (HPLMN) 104 is a home PLMN to which a user is subscribed for managing a user profile. Visited public land mobile networks (VPLMNs) 106, 108 and 110 are visited PLMNs of an area to which a user roams and moves.

When the UE exits an area-1 102 of the HPLMN 104 and roams to an area-2 100, the UE can no longer receive service from the HPLMN 104. Therefore, the UE selects the VPLMN 106, 108 or 110 of the area-2 100 to receive a mobile communication service and is to be registered to the selected VPLMN 106, 108 or 110. Referring to FIG. 1, three VPLMNs are present in the area-2 100. A roaming contract is made between the VPLMNs 106, 108 and 110 and the HPLMN 104. If the UE can receive services from all the three VPLMNs in the visited area, the UE selects one of the VPLMNs.

In this case, the UE automatically selects a VPLMN for roaming. Once the UE selects a VPLMN, the selected VPLMN is not changed until a new PLMN is selected. That is, an HPLMN provider cannot arbitrarily change the VPLMN selected and used by the roaming UE. However, if another VPLMN provides a better service than the VPLMN currently being used by the UE registered thereto or is more proper to a billing policy of the HPLMN, a change to a VPLMN to be used by the UE can be advantageous for both the HPLMN and the user. However, in this case, a method for registering the UE to an associated VPLMN is not provided.

Accordingly, there is a need for an improved method and system for selecting a visited network (VPLMN) to be used by a user equipment (UE).

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and system for receiving a preferred visited public land mobile network (VPLMN) list from a home public land mobile network (HPLMN) when selecting a VPLMN for providing an optimal service to a roaming user equipment.

In accordance with an aspect of exemplary embodiments of the present invention, there is provided a method for selecting a visited network (VPLMN) to be used by a user equipment in a wireless communication system. The method includes receiving a preferred visited network list from a home network (HPLMN) when the user equipment is registered to a visited network. It is determined whether the visited network is required to be reselected on a basis of the received preferred visited network list. The visited network is reselected according to a determination result and the user equipment is registered to the reselected visited network.

In accordance with another aspect of exemplary embodiments of the present invention, there is provided a wireless communication system. The system includes a user equipment for receiving a currently available preferred visited network (VPLMN) list and selecting an optimal visited network in current location by referring to the received list. A home network (HPLMN) creates the preferred visited network list and sends the preferred visited network list to the user equipment.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 schematically illustrates a roaming state of a user equipment (UE) to which the present invention is applied;

FIGS. 2A and 2B are flowcharts illustrating an operation for sending an available visited public land mobile network (VPLMN) list from the UE to a home public land mobile network (HPLMN) and a flowchart illustrating an operation for sending a preferred VPLMN list from the HPLMN to the UE, respectively;

FIG. 3 is a flow diagram illustrating a connection structure of a control signal between the UE and the HPLMN when the UE uses an update location ack message in a location area update process;

FIG. 4 is a flow diagram illustrating a connection structure of a control signal between the UE and the HPLMN when the UE uses an update location negative response message in the location area update process;

FIGS. 5A and 5B are flowcharts illustrating an operation for sending an available VPLMN list from the UE to the HPLMN in response to a request of the HPLMN and an operation for sending a preferred VPLMN list based on the received list from the HPLMN to the UE, respectively;

FIG. 6 is a flow diagram illustrating a process for delivering a preferred VPLMN list from the HPLMN using a short message service (SMS);

FIGS. 7A and 7B are flowcharts illustrating an operation for sending a preferred VPLMN list 1 from the HPLMN only using location information of the UE without receiving an available VPLMN list from the UE; and

FIG. 8 illustrates a message flow between the UE and the HPLMN to perform the processes of FIGS. 7A and 7B.

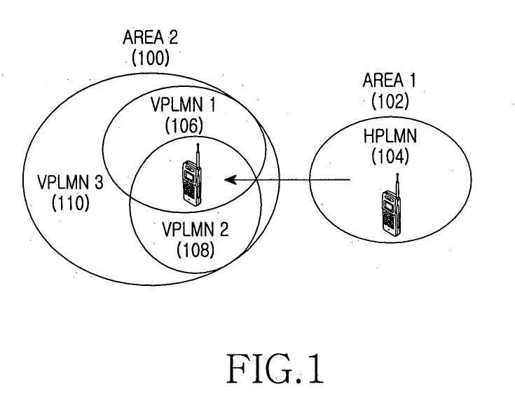

Throughout the drawings, like reference numbers will be understood to refer to like elements, features, and structures.

### DETAILED DESCRIPTION OF EXEMPLARY EMBODIMENTS

The matters defined in the following description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In accordance with an exemplary embodiment of the present invention, a roaming user equipment (UE) receives a preferred visited public land mobile network (VPLMN) list. A home public land mobile network (HPLMN) can receive an available VPLMN list from the roaming UE and send a preferred VPLMN list to the UE. Alternatively, the HPLMN can send the preferred VPLMN list to the UE using location information of the UE without receiving the available VPLMN list.

In the method in which the UE sends the available VPLMN list to the HPLMN, the UE can either send the available VPLMN list in response to a request of the HPLMN or without the request of the HPLMN.

The available VPLMN list to be sent from the UE to the HPLMN can be a list of VPLMNs currently available in the UE and can be a list including an indicator for indicating a PLMN for current use/registration of the UE. Moreover, the available VPLMN list preferably includes radio access technology (RAT) information accompanied with each VPLMN and location information of the UE. For example, VPLMN_A, VPLMN_A+WCDMA, VPLMN_A+WCDMA+Cell_ID, and the like can be included in the available VPLMN list.

In accordance with an exemplary embodiment of the present invention, there are two types of preferred VPLMN lists. First, the preferred VPLMN list can be a list in which a priority is set for a VPLMN by applying a preference of the HPLMN to the VPLMNs of the available list received from the UE. Second, the preferred VPLMN list may be arbitrarily created by the HPLMN using location information received from the UE. To distinguish the two types, the latter list is referred to as the preferred VPLMN list 1. The preference can be independently set by the HPLMN and can be set by a roaming contract with the VPLMN, billing information, and the like. The preferred VPLMN list can also include elements of an available VPLMN list, RAT information, location information, and the like. When sending the preferred VPLMN list or the preferred VPLMN list 1 to the UE, the HPLMN can send additional information to be used for VPLMN selection by the UE.

The additional information can include a time at which the UE is again registered to another VPLMN, a condition under which the UE is again registered to another VPLMN, a time at which a received preferred VPLMN list (including the preferred VPLMN list 1) expires, a time or interval at which the preferred VPLMN list is refreshed, and the like.

The time at which the UE is again registered to another VPLMN indicates when the UE refers to the preferred VPLMN list (including the preferred VPLMN list 1) and determines whether to change the VPLMN to which it is registered. The condition under which the UE is again registered to another VPLMN is used when the HPLMN commands a VPLMN change if the UE or the associated VPLMN satisfies a specific condition. The time at which the received preferred VPLMN list (including the preferred VPLMN list 1) expires indicates when an available time expires after the user receives the preferred VPLMN list (including the preferred VPLMN list 1). When the location of the user is changed, the preferred VPLMN list (including the preferred VPLMN list 1) may be changed. To reflect this change, the preferred VPLMN list (including the preferred VPLMN list 1) can be refreshed at a predetermined interval or upon occurrence of a specific event and is retransmitted to the HPLMN. The specific event occurrence time or predetermined interval can be a time or interval at which the preferred VPLMN list (including the preferred VPLMN list 1) is refreshed.

Next, exemplary embodiments of the present invention will be described in detail.

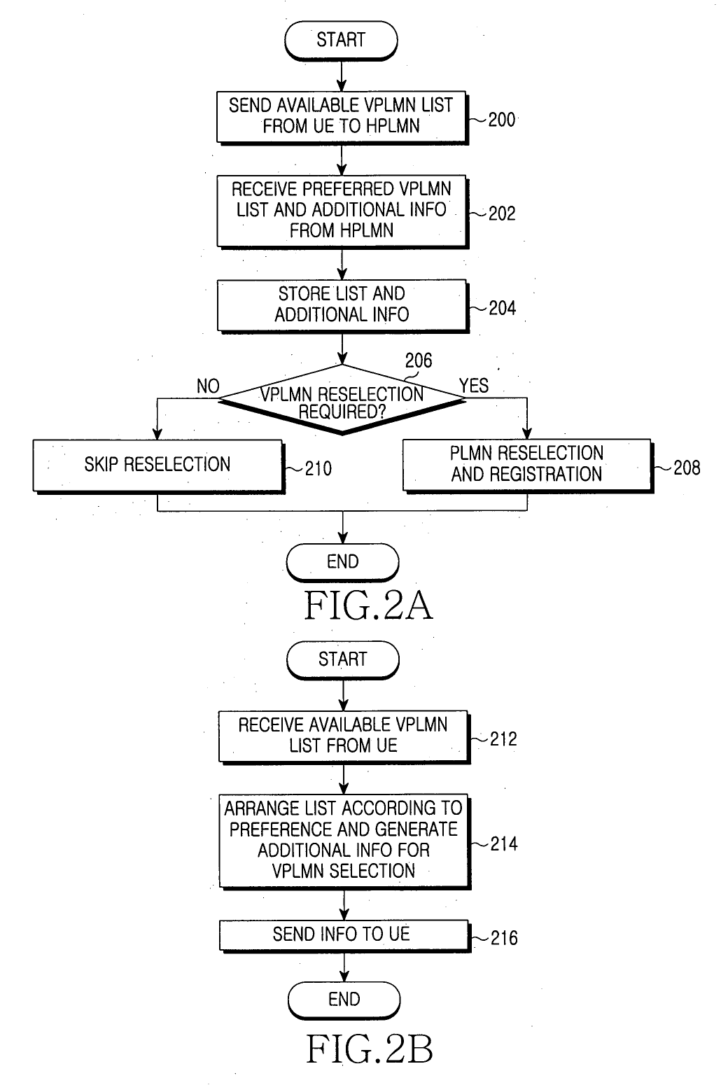

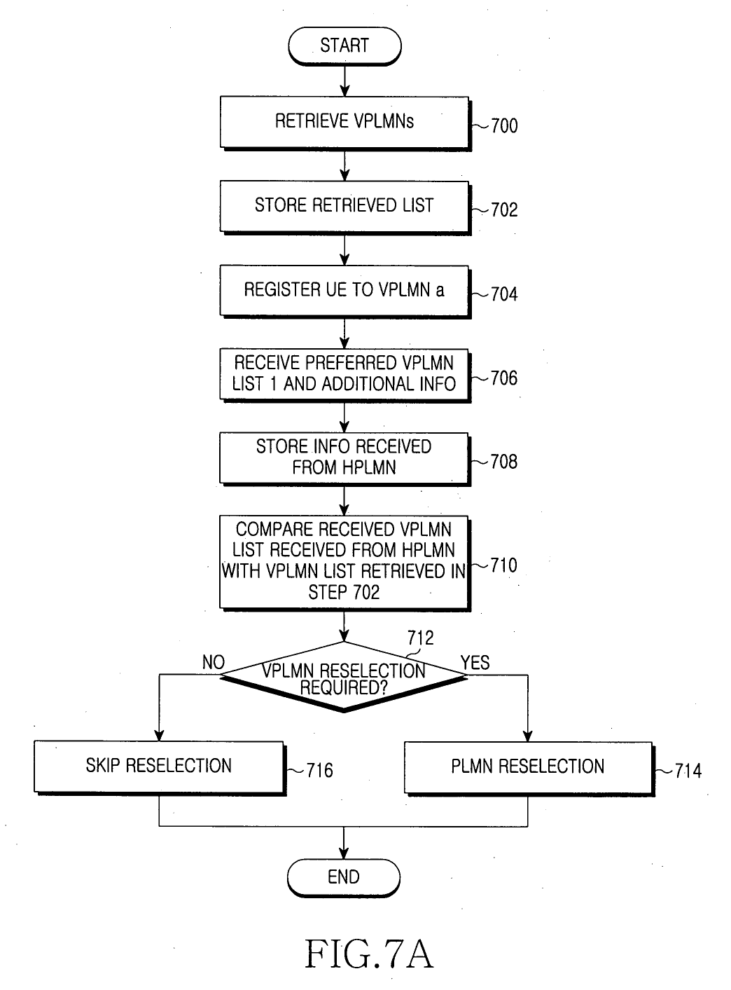

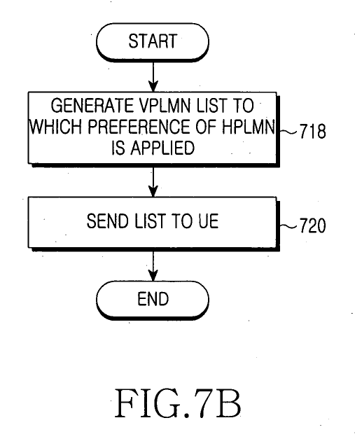

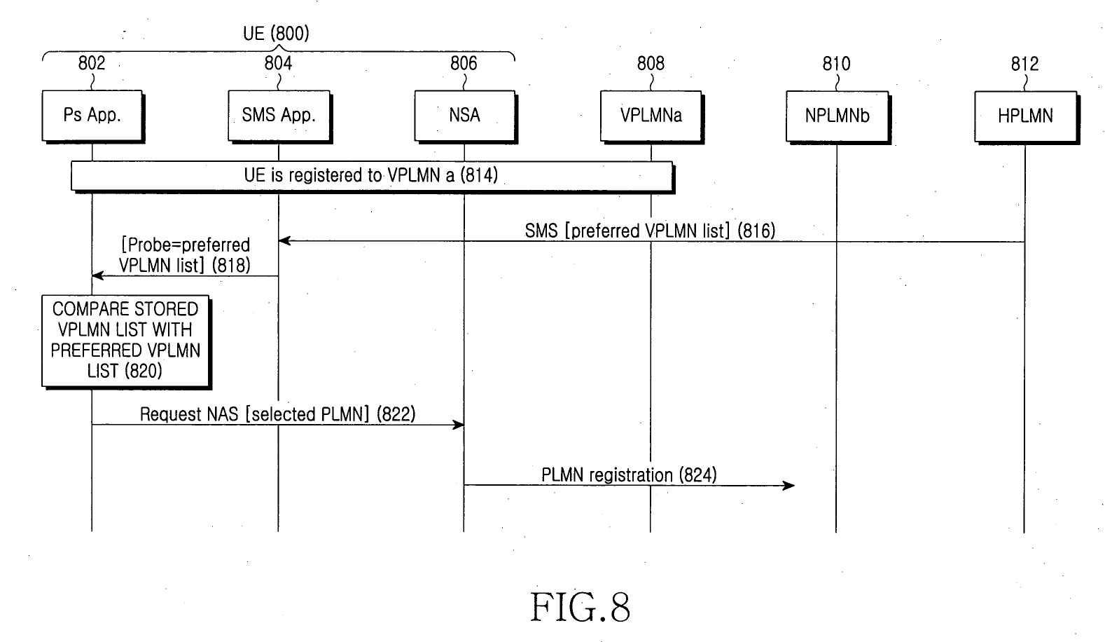

FIGS. 2A, 2B, 3, 4, 5A, 5B and 6 illustrate a method by which an HPLMN receives an available VPLMN list from a roaming UE and provides a preferred VPLMN list, and FIGS. 7A, 7B and 8 illustrate a method in which the HPLMN provides the preferred VPLMN list using location information of the UE without receiving the available VPLMN list from the UE.

FIGS. 2A and 2B illustrate a first exemplary embodiment of the present invention in which the UE first starts VPLMN selection. FIG. 2A illustrates the operation of the UE and FIG. 2B illustrates the operation of the HPLMN.

First, the operation of the UE will be described.

Referring to FIG. 2A, the UE sends a currently available VPLMN list to the HPLMN in step 200. Then, the UE receives a preferred VPLMN list and additional information from the HPLMN in step 202 and stores the received list and information in step 204. The received list and information can be stored using a memory of a device itself or a subscriber identity module/universal subscriber identity module (SIM/USIM). Alternatively, the information may not be stored since step 204 can be omitted according to the option of the UE. Also in this case, a temporary storage process is required for a comparison with previous data. Then, the UE determines whether VPLMN reselection is required in step 206. If a VPLMN currently being used by the UE registered thereto is not included in the received preferred VPLMN list, the reselection is required. If the VPLMN currently being used by the UE registered thereto is included in the received preferred VPLMN list, the reselection is not required. If the reselection is determined to be required, the UE proceeds to step 208 to perform a process for reselecting a VPLMN and registering the UE thereto. However, if the reselection is determined not to be required, the UE proceeds to step 210 to end the process without reselecting a VPLMN.

Next, the operation of the VPLMN will be described.

Referring to FIG. 2B, the HPLMN receives an available VPLMN list from the UE in step 212. Then, the HPLMN creates a preferred VPLMN list based on the received list and generates additional information in step 214 and then sends the preferred VPLMN list and the additional information to the UE in step 216.

To perform the processes of FIGS. 2A and 2B in a first exemplary embodiment of the present invention, a non-access stratum (NAS) message of a conventional wireless communication network can be used. Location area update (LAU), routing area update (RAU) and attach processes can be used. The LAU process is performed periodically or when a location area is changed in a circuit switched (CS) domain. The RAU process is performed periodically or when a routing area is changed in a general packet radio service (GPRS). The location area and the routing area are formed with at least one cell, respectively, and are units in which the location of the UE is managed in the GPRS. The attach process is used to register the UE to a network immediately after the UE is switched on. In an example embodiment of the present invention, an example of the LAU process will be described. Similarly, the present invention can be applied to the RAU and attach processes.

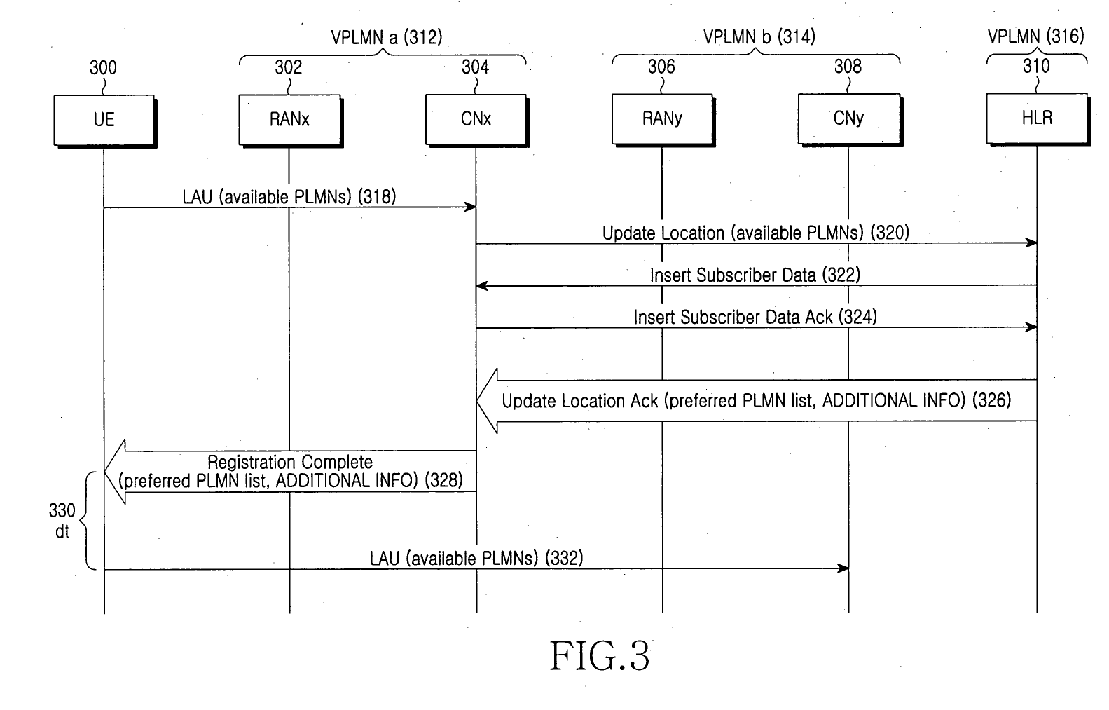

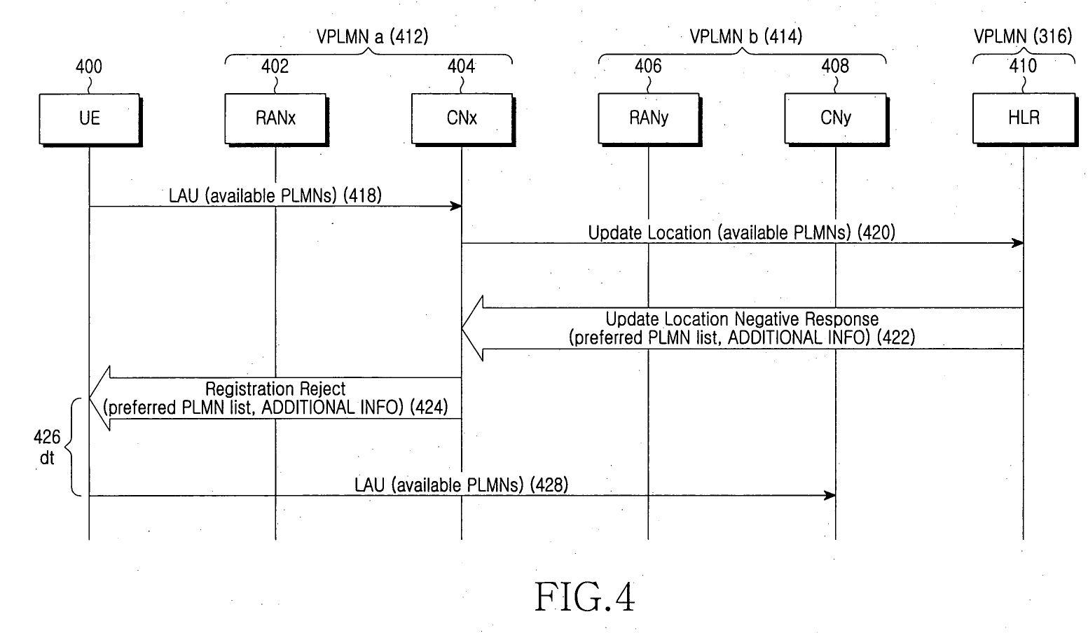

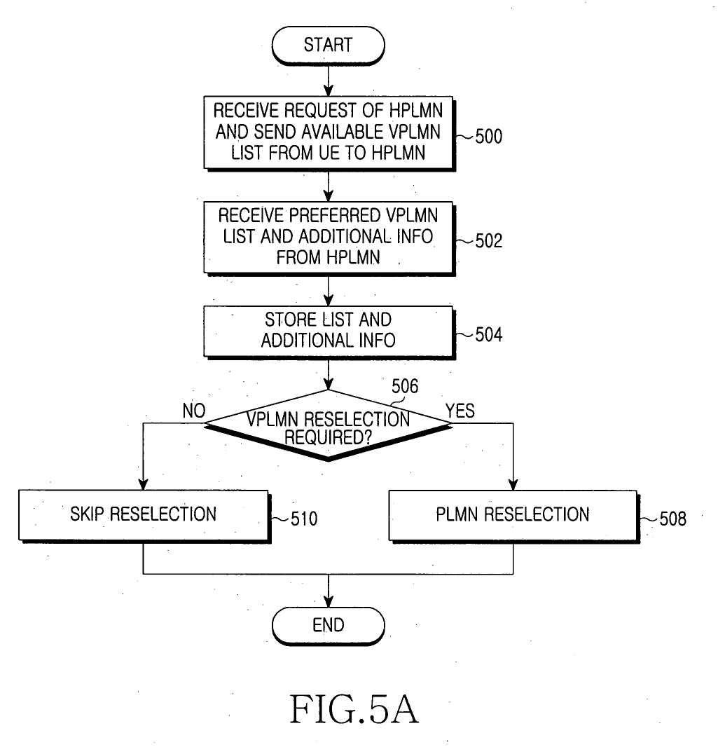

FIG. 3 illustrates a method for sending a preferred VPLMN list of the HPLMN using an update location ack message, and FIG. 4 illustrates a method for sending the preferred VPLMN list of the HPLMN using an update location negative response message. The update location ack message indicates that the LAU process has succeeded and the update location negative response message indicates that the LAU process has failed.

First, the case where the update location ack message is used will be described with reference to FIG. 3.

A VPLMN a 312 is a VPLMN for current use/registration of a UE 300, and is constructed with a radio access network x (RANx) 302 and a core network x (CNx) 304. A VPLMN b 314 is a VPLMN for a change after the UE 300 receives a preferred VPLMN list from an HPLMN, and is constructed with a RANx 306 and a CNy 308. A home location register (HLR) 310 is a primary data storage space for storing information regarding all subscribers and data related to service provision in an associated PLMN. In a mobile communication network, the location of the UE 300 is continuously registered. In a description of the exemplary embodiment of the present invention, the HLR 310 is proposed as a network entity related to PLMN selection in the HPLMN 316. Alternatively, other entities can function as the network entity related to PLMN selection.

First, the UE 300 includes an available VPLMN (or PLMN) list in an LAU message and then sends the message to the CNx 304 in step 318. Then, the CNx 304 performs a process for registering the location of the UE 300 to the HLR 310 of the HPLMN 316 in steps 320 to 326.

That is, the CNx 304 includes the available VPLMN (or PLMN) list received from the UE 300 in an update location message and then sends the message to the HLR 310 of the HPLMN 316 in step 320. Then, the HLR 310 provides the CNx 304 with an insert subscriber data message to deliver user subscription information in step 322. The message is the same as that transmitted in the conventional LAU process. Then, the CNx 304 provides the HLR 310 with an insert subscriber data ack message of positive acknowledgement to the insert subscriber data message in step 324. Then, the HLR 310 provides the CNx 304 with an update location ack message indicating that the location registration process has been completed in step 326. At this time, the update location ack message contains a preferred VPLMN list and additional information.

Next, the CNx 304 includes the preferred VPLMN list and the additional information received from the HLR 310 in a registration complete message and then sends the message to the UE 300 in step 328. After a time of dt 330 has elapsed, the UE 300 retries the LAU process and is registered to a new VPLMN 314 in step 332. Herein, the time of dt 330 is included in the additional information and indicate when a change to the new VPLMN for the UE 300 is made. The time of dt 330 can be set in all time units of a second, minute, hour, and the like. When the time of dt 330 is included in the additional information, the UE 300 receives the registration complete message and attempts registration to the new VPLMN after the time of dt 330 has elapsed.

Next, the case where a preferred PLMN list is sent using an update location negative response message of the LAU process will be described with reference to FIG. 4.

Since elements 400 to 410 of the FIG. 4 are the same as those of FIG. 3, a detailed description of these elements is omitted.

The UE 400 includes an available VPLMN list in an LAU message and then sends the message to the CNx 404 in step 418. The CNx 404 includes the available VPLMN list received from the UE 400 in an update location message and then sends the message to the HLR 410 in step 420. The HLR 410 includes a preferred VPLMN list and additional information in an update location negative response message and then sends the message to the CNx 404 in step 422. The CNx 404 includes the preferred VPLMN list and the additional information in a registration reject message and then sends the message to the UE 400. Since a time of dt 426 is the same as that of FIG. 3, a description is omitted. The UE 400 attempts registration to a new VPLMN 414 based on the preferred VPLMN list after the time of dt 426 has elapsed in step 428.

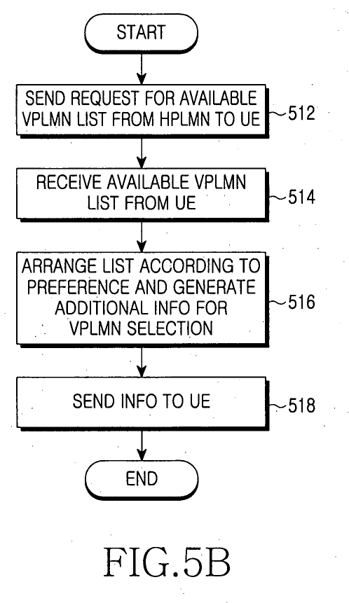

Next, a second exemplary embodiment of the present invention in which the UE sends an available VPLMN list to the HPLMN in response to a request of the HPLMN will be described with reference to FIGS. 5A and 5B.

FIG. 5A is a flowchart illustrating the operation of the UE.

Referring to FIG. 5A, the UE receives a request from the HPLMN and then sends a currently available VPLMN list to the HPLMN in step 500. The UE receives a preferred VPLMN list and additional information from the HPLMN in step 502 and stores the preferred VPLMN list and the additional information according to option of the UE in step 504. The UE determines whether VPLMN reselection is required in step 506 as in FIG. 2. If the VPLMN reselection is required, a PLMN selection process is performed in step 508. However, if the reselection is not required, the PLMN selection process ends without reselection in step 510.

FIG. 5B is a flowchart illustrating the operation of the HPLMN.

The HPLMN requests that the UE should send an available VPLMN list in step 512, and then receives the available VPLMN list from the UE in step 514. Then, the HPLMN generates a preferred VPLMN list and generates additional information for VPLMN selection in step 516. The preferred VPLMN list and the additional information are delivered to the UE in step 518.

On the other hand, unstructured supplementary service data (USSD) and a short message service (SMS) message corresponding to an application message used in the conventional wireless communication network can be used to perform the processes of FIGS. 5A and 5B in the second exemplary embodiment of the present invention. An USSD application is predefined between the user and a PLMN provider and uses a message delivery method in which an intermediate network entity does not intervene. An example of USSD may be *89. In an exemplary embodiment of the present invention, the SMS will be described. Similarly, the present invention can be applied to the USSD.

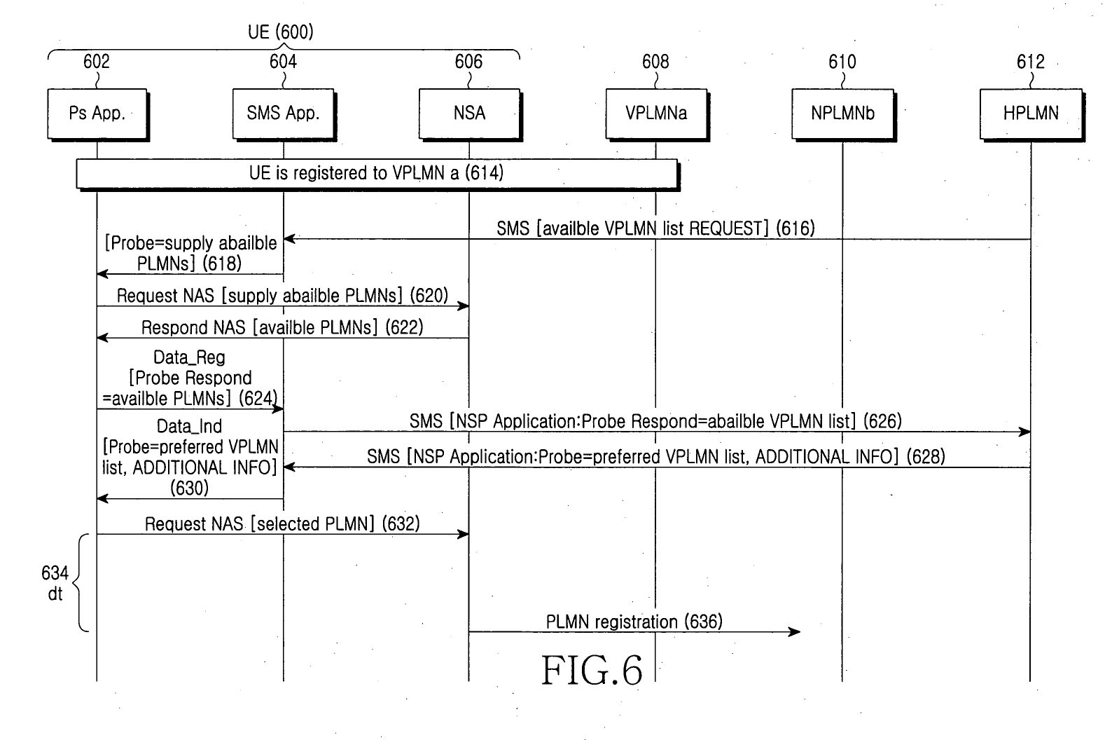

FIG. 6 illustrates a process in which the HPLMN provides the UE with a preferred VPLMN list using the SMS.

In a UE 600, an SMS application 604 sends and receives an SMS message like the conventional SMS application. An exemplary embodiment of the present invention includes a function for triggering a PLMN selection (Ps) application 602 for an SMS related to PLMN selection among received SMS messages. The SMS application 604 can directly detect the SMS related to the PLMN selection. Since a specific indicator is contained in the SMS message, the SMS application 604 can identify the SMS related to the PLMN selection using the indicator. The Ps application 602 is an application program mounted in the UE 600 and receives an SMS message related to PLMN selection from the SMS application 604. The Ps application 602 collects required information according to the message and sends the collected information to the SMS application 604. This process may be transparent or not transparent to the user. An NAS 606 is responsible for NAS level signalling in the UE 600. All the three functional sections 602, 604, and 606 are present in the UE 600. A VPLMNa 608 is a VPLMN to which the UE 600 is currently registered, and a VPLMNb 610 is a VPLMN to which the UE 600 desires to move. An HPLMN 612 can function as any network entity within the HPLMN.

Referring to FIG. 6, the UE 600 is registered to the VPLMNa 608 in step 614. The HPLMN 612 sends an SMS message for requesting a currently available VPLMN list to the UE 600 in step 616. Upon receiving an SMS related to VPLMN selection, the SMS application 604 triggers the Ps application 602 in step 618. The Ps application 602 sends the available VPLMN list request to the NAS 606 within the UE 600 in step 620. The NAS 606 creates the available VPLMN list and then sends the list to the Ps application 602 in step 622. The Ps application 602 sets the available VPLMN list proper for an SMS format and then sends the list to the SMS application 604 in step 624. The SMS application 604 sends the available VPLMN list to the HPLMN 612 in step 626. The HPLMN 612 generates a preferred VPLMN list and then sends the preferred VPLMN list and additional information to the UE 600 in step 628. The SMS application 604 receives the information sent in step 628 and provides the received SMS message to the Ps application 602 in step 630. The Ps application 602 extracts the preferred VPLMN list and the additional information from the SMS message and sends a command for a VPLMN reselection process to the NAS 606, if needed, in step 632. Since a time of dt 634 is the same as those of FIGS. 3 and 4, a description is omitted. After the time of dt 634 has elapsed, the NAS 606 starts registration to a new VPLMN 610 when the VPLMN is reselected in step 636.

On the other hand, the UE can send an available VPLMN list to the HPLMN as illustrated in FIG. 2, in a process using a message at an application level as illustrated in FIG. 6. That is, steps 616 and 618 of FIG. 6 may be omitted.

FIGS. 7A and 7B are flowcharts illustrating a third exemplary embodiment of the present invention in which the HPLMN sends a preferred VPLMN list 1 only using location information of the UE without receiving an available VPLMN list from the UE.

FIG. 7A is a flowchart illustrating the operation of the UE.

In steps 700 to 704, the UE first retrieves VPLMNs for registration to the VPLMNa as in FIG. 6 and then stores a list of the retrieved VPLMNs in the UE. Then, the UE receives a preferred VPLMN list 1 and additional information from the HPLMN in step 706 and stores the received information in step 708. At this time, step 708 may be omitted as in the above-described flowchart. In step 710, the UE compares the preferred VPLMN list 1 received in step 706 with the VPLMN list retrieved in step 702. The UE determines whether VPLMN reselection is required in step 712. When a VPLMN mapped to the highest priority of the preferred VPLMN list 1 is present in the retrieved VPLMN list, VPLMN reselection is required. If the VPLMN reselection is determined to be required, the UE performs PLMN reselection in step 714. However, if the VPLMN reselection is determined not to be required, VPLMN selection ends without reselection in step 716. For example, when a VPLMN to which the UE is currently registered is C, priority-by-priority VPLMNs retrieved by the UE are C-A-B, and the preferred VPLMN list 1 is A-C-D, the UE again sets priorities in an intersection set between the VPLMN list retrieved by the UE and the preferred VPLMN list 1. In this case, the order of A-C is set. Therefore, the UE is again registered to the VPLMN A.

FIG. 7B illustrates the operation of the HPLMN.

The HPLMN generates a preferred VPLMN list 1 using location information of the UE detected when the UE is registered to the VPLMNa in step 718 and then delivers the preferred VPLMN list 1 to the UE in step 720.

FIG. 8 illustrates a message flow between the UE and the HPLMN to perform the processes of FIGS. 7A and 7B.

Since entities 800 to 812 of FIG. 8 are the same as those of FIG. 6, a description is omitted.

In step 814, the UE 800 is registered to the VPLMNa 808. At this time, a list of VPLMNs retrieved for selection is stored in the UE 800 or a device thereof. In step 816, the HPLMN 812 sends a preferred VPLMN list 1 to the UE through an SMS message. In step 818, the SMS application 804 triggers the Ps application 802 and then sends the received preferred VPLMN list 1. In step 820, the Ps application 802 compares the VPLMN list stored in the UE 800 with the received preferred VPLMN list 1. If VPLMN reselection is determined to be required, the Ps application 802 sends a command for a VPLMN reselection process to the NAS 806 in step 822. The NAS 806 attempts the VPLMN reselection in step 824.

As is apparent from the above description, the present invention has at least the following advantages.

The present invention can extend an opportunity of a user to receive a service analogous to an HPLMN by enabling the HPLMN to manage a VPLMN to be used by a roaming user. The HPLMN can provide the user with a better service by selecting a VPLMN most proper for a policy of the HPLMN.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for selecting a visited network (VPLMN) to be used by a user equipment in a wireless communication system, comprising:
receiving a preferred visited network list from a home network (HPLMN) when the user equipment is registered to a visited network;
determining whether the visited network is required to be reselected on a basis of the received preferred visited network list; and
reselecting the visited network according to a determination result and registering the user equipment to the reselected visited network.

2. The method of claim 1, further comprising:
sending a currently available visited network list from the user equipment to the home network before the preferred visited network list is received.

3. The method of claim 2, wherein the user equipment sends the currently available visited network list to the home network while performing a location area update (LAU) process, the preferred visited network list comprising at least one of a response message indicating that the LAU process has succeeded and a response message indicating that the LAU process has failed and sending the message to the user equipment.

4. The method of claim 2, wherein the user equipment sends the currently available visited network list to the home network in response to a request from the home network.

5. The method of claim 4, wherein the home network requests that the user equipment should send the currently available visited network list through a short message service (SMS), the user equipment sending the currently available visited network through the SMS.

6. The method of claim 2, wherein receiving the preferred visited network list comprises:
receiving, by the user equipment, the preferred visited network list and additional information for registration to the reselected visited network.

7. The method of claim 6, wherein the additional information comprises a time at which the user equipment changes a visited network, the method further comprising:
sending the currently available visited network list from the user equipment to the home network when the time is reached.

8. The method of claim 1, wherein the preferred visited network list is created in the home network using location information received from the user equipment.

9. The method of claim 8, wherein the home network sends the preferred visited network list from the home network to the user equipment using a short message service (SMS).

10. A wireless communication system, comprising:
a user equipment for receiving a currently available preferred visited network (VPLMN) list and selecting an optimal visited network in current location by referring to the received list; and
a home network (HPLMN) for creating the preferred visited network list and sending the preferred visited network list to the user equipment.

11. The wireless communication system of claim 10, wherein the home network receives a currently available visited network list from the user equipment and creates the preferred visited network list using the list received from the user equipment.

12. The wireless communication system of claim 11, wherein the user equipment sends the currently available visited network list to the home network in response to a request of the home network.

13. The wireless communication system of claim 10, wherein the home network sends the preferred visited network list and additional information for registering the user equipment to a reselected visited network.

14. The wireless communication system of claim 10, wherein the home network receives location information of the user equipment from the user equipment and creates the preferred visited network list using the location information.

15. A computer readable medium of instructions for controlling a user equipment to select a visited network (VPLMN) in a wireless communication system, comprising:
a first set of instructions adapted to control the user equipment to receive a preferred visited network list from a home network (HPLMN) when the user equipment is registered to a visited network;
a second set of instructions adapted to control the user equipment to determine whether the visited network is required to be reselected on a basis of the received preferred visited network list; and
a third set of instructions adapted to control the user equipment to reselect the visited network according to a determination result and register the user equipment to the reselected visited network.

16. The computer readable medium of claim 15, further comprising:
a fourth set of instructions adapted to control the user equipment to send a currently available visited network list from the user equipment to the home network before the preferred visited network list is received.

17. The computer readable medium of claim 16, further comprising:
a fifth set of instructions adapted to control the user equipment to send the currently available visited network list to the home network while performing a location area update (LAU) process.

18. The computer readable medium of claim 17, wherein the preferred visited network list comprises at least one of a response message indicating that the LAU process has succeeded and a response message indicating that the LAU process has failed and sending the message to the user equipment.

19. The computer readable medium of claim 16, wherein the fourth set of instructions are adapted to control the user equipment to send the currently available visited network list to the home network in response to a request from the home network.

20. The computer readable medium of claim 16, wherein the first set of instructions is adapted to control the user equipment to receive the preferred visited network list and additional information for registration to the reselected visited network.

21. The computer readable medium of claim 20, wherein the additional information comprises a time at which the user equipment changes a visited network, and wherein the fourth set of instructions are adapted to control the user equipment to send the currently available visited network list to the home network when the time is reached.

22. The computer readable medium of claim 15, wherein the preferred visited network list is created in the home network using location information received from the user equipment.

23. The computer readable medium of claim 15, wherein the first set of instructions are adapted to control the user equipment to receive the preferred visited network list from the home network in a short message service (SMS) message.
